(19) United States
(12) Patent Application Publication
(10) Pub. No.: US 2002/0046118 A1
(43) Pub. Date: Apr. 18, 2002

(54) Method of linking advertisements on the World Wide Web with advertisements in other media

(76) Inventor: Geoffrey Minte, Falmouth, ME (US)

Correspondence Address: Thomas L. Bohan & Associates, Suite 202, 371 Fore Street, Portland, ME, 04101, US

(21) Appl. No.: 09/956,496

(22) Filed: Sep. 19, 2001

Related U.S. Application Data
(63) Continuation-in-part of application No. 09/663,970, filed on Sep. 19, 2000, now abandoned.

(51) Int. Cl. G06F 17/60

(52) U.S. Cl. 705/14; 705/10

(57) ABSTRACT

An advertising method that couples advertising content of several advertising media together, one of the media being the World Wide Web. Identifiers are included in initial advertisements placed in Web and non-Web media, and direct the person viewing or hearing those advertisements to a Web site that is a collection of linked Web-pages containing additional information relating to the initial advertisements. The viewer can click on advertisement-specific “buttons” to get further information about one or more of the products or services advertised in the initial advertisement.

This application is a Continuation-in-Part of the co-pending, commonly owned U.S. application Ser. No. 09/663,970, filed on Sep. 19, 2000.

### BACKGROUND OF THE INVENTION

1. Field of the Invention

This invention relates to the field of advertising. More particularly this invention relates to coordinated advertising across two or more communication media. More particularly still, this invention relates to such coordinated advertising across two or more communication media, whereby one of the media is the World Wide Web.

2. Description of the Related Art

Advertising methods in general are specific to a particular communication medium, such as television, radio, the Internet, print, etc., and, consequently, exploit only those attributes present in the particular medium. The advantages of other media are unavailable to such medium-specific advertising methods. While an advertising campaign may be carried out using several different media, each advertisement stands by itself within the limiting confines of its particular medium of expression.

Previous advertising methods that “span” two or more communications media, thus gaining the benefits (and detriments) of each medium, have been limited. These previous methods include that of Mayer (U.S. Pat. No. 5,774,534; 1998) which relates to a method of routing telephone calls received from television viewers. In this method, a telephone number is displayed during a television broadcast and the viewer is encouraged to call that number to obtain more information about the product or to purchase the product. The same telephone number is displayed in conjunction with a number of different advertisements, but the calls are routed to different appropriate terminating telephone stations, depending on the context of the telephone call, such as the time the telephone call was made. The method according to Mayer may be adequate for processing a purchase once a viewer has decided to buy an advertised product; however, due to its reliance on an audio medium, it is limited in the amount and type of information about the goods in question it can provide for the prospective purchaser.

The World Wide Web [Web] has become an accepted advertising medium in the past few years. The amount of money spent by advertisers on Web advertising, however, is paltry in comparison to the amount spent on similar campaigns in print, radio, and television media. Furthermore, virtually all advertising methods using the Web as a medium are specific to the Web and only the Web. As a consequence, these Web-specific advertising methods are limited by the Web's ability to grab the consumer's attention. This limitation of the Web is discussed in greater detail below.

Comparing television with the Web, both of these media have certain characteristics that advertisers consider to be advertising strengths. One strength of television advertising is that it is directed to a passive viewer. Information, including advertising, is placed before the viewer. The sound and image content is controlled by the stations and the television networks. The passive behavior of the viewer on the one hand and the complete control over content on the other hand make television an optimal medium for grabbing and directing a viewer's attention.

The passivity of the viewer stems from a lack of interactivity between the viewer and the broadcasting system. The disadvantage of this lack of interactivity with the viewer means that advertising cannot be targeted to the individual viewer. An attempt to overcome the inability of television advertising to tailor its ads to the particular viewers is disclosed by Hite et al. (U.S. Pat. No. 5,774,170;1998), which teaches a system and method for delivering targeted advertisements to consumers by enhancing local or regional television and radio advertising. The invention of Hite et al. is directed to blocking out commercials that are broadcast over cable-television networks and replacing them with different commercials targeted for audiences in specific geographic regions or locales. Advertisements substituted in this manner still suffer the inherent limitations of television discussed above.

A further disadvantage of television advertising is that it can only provide a set amount of information in a limited and, typically, very brief, period of time. Thus, no matter how interested a viewer may be, the television advertisement can simply not provide the detailed information for potential consumers who are interested in obtaining more information about the product or service being advertised.

In contrast to traditional passive advertising media such as the television, the Web is a medium which encourages a potential consumer to take an active role in pursuit of information. Information generally does not come to the user by mere virtue of the computer and Web browser being active and linked to the Internet. The Web user actively selects, or initiates, a search for desired information by entering a specific URL (Uniform Resource Locator) for a specific Web page, by entering a particular search phrase or term in a search engine, or by selecting an advertisement on a Web page extant on the user's Web browser. The user, in an active role, searches or traverses the Web to acquire the desired information. If a user is curious about a particular advertised item, he or she can actively search the Web to learn virtually all there is to know about that item on the Web. In this way, the Web is able to offer a greater depth of advertising content than television. The user may also become “involved” with an item of interest through on-line interactive means such as surveys, contests, user feedback forms, and ultimately, purchases.

The emergence and growth of the Web has been due in great part to its development as a forum for commerce. Concomitant with this development, advertising methods alone or in conjunction with purchasing methods have been developed that are specific to the Web. For a concise history of the development of advertising on the Web, see Wheelwright, Geoff, Reckoning the Web's Ad Power, NATIONAL POST, SPECIAL REPORT: IT MONTHLY, Feb. 15, 1999. While exploiting the advertising strengths of the Web, these Web-specific methods fail to exploit the advertising benefits that other communications media, such as radio and television, have to offer. Foremost among these unexploited benefits is the ability to actively present advertising content to large numbers of people who are in a passive role.

Several Web-specific advertising methods are known. Wexler (U.S. Pat. No. 5,960,409; 1999) teaches a system for on-line third-party accounting and a method for providing statistical information. The invention of Wexler is directed to a method of third-party accounting wherein requests made from a first party's web page for a second party's (i.e., an advertiser's) web site are intercepted by the third-party's web site where the accounting is performed. The third-party's web site then automatically redirects the request to the intended advertiser's web site, and then the accounting information is provided to the advertiser and the first party; however, no provision is made for television advertising.

Wodarz et al. (U.S. Pat. No. 5,999,912; 1999) teaches a method and computer program for providing dynamic advertising scheduling, display, and tracking. According to this method, an advertisement from a set of stored advertisements is displayed on a web page when the page is accessed. The advertisement presented to the viewer is alternated upon subsequent visits to the Web page. No beneficial attributes of television or other advertising media are exploited by the invention of Wodarz et al.

Angles et al. (U.S. Pat. No. 5,933,811; 1999) teaches a similar system and method for delivering customized advertisements within interactive communication systems by means of a system of computers interconnected via the Internet. In the system of Angles et al., when a consumer, through the consumer's computer, accesses an advertisement-offering that exists on a content-provider's server, an advertising request is sent to an advertisement computer. This advertisement computer then generates a custom advertisement based on a consumer profile previously obtained for that consumer. The customized advertisement is then sent to the consumer in conjunction with the offering that the consumer originally requested. Although this method does provide advertising that is customized to the consumer profile, the invention of Angles et al. relies solely on the Web as a medium for advertising. Consequently, such advertising is subject to the limitations inherent in the Web, specifically, that initially the viewer actively searches for information, and, in effect, decides which information he or she will receive.

Other methods of providing purchasing capability via the Internet are known. Hartman et al. (U.S. Pat. No. 5,960,411; 1999) teaches a method and system for placing a purchase order over the Internet. The invention of Hartman et al. is directed at a single-step method of purchasing goods, and does not involve advertising directly. Bezos et al. (U.S. Pat. No. 6,029,141; 2000) teaches an Internet-based customer-referral system in which associates having Web-pages “refer” customers via hypertext links to the web-pages of merchants, and receive a commission when customers so-referred purchase an item through the merchants' Web-page. This system is a commission-for-marketing method and does not provide for evaluating the effectiveness of an advertising campaign.

A system and method for assessing effectiveness of an Internet marketing campaign is taught by d'Eon et al. (U.S. Pat. No. 6,006,197; 1999). This method is directed to the evaluation of the effectiveness of an arbitrary Web advertisement and makes no provisions for any specific method of advertisement.

Another method of advertising on the Web is taught by Merriam et al. (U.S. Pat. No. 5,948, 061; 1999). The Merriam et al. invention is directed towards a method of delivering, targeting, and measuring advertising-effectiveness over networks. Affiliate web sites contract for the services of an advertisement server Web site. When a user accesses an affiliate Web site, the advertisement server Web site sends to the user unrequested advertisement information (from the perspective of the user). Additionally, an advertisement evaluation step is taught by Merriam et al. Arising from its similarities to the invention of Angles et al., the Merriam et al. invention is likewise limited by a reliance on the Web as a sole medium for advertising.

Gardenswartz et al (U.S. Pat. No. 6,055,573; 2000) teaches a method, system, and a computer program for communicating with a computer, based on a purchase profile of a particular consumer. The purchase profile is obtained from data collected by participating stores that record purchases of their patrons and forward the information to the purchase-profile database. The Gardenswartz et al. invention is directed to selecting an advertisement and delivering this advertisement to a consumer, based on the consumer's purchases made in bricks-and-mortar stores, and does not make use of advertising on the Web.

Moncreiff (U.S. Pat. No. 6,061,716; 2000) teaches a computer network chat room, based on a channel broadcast in real-time, in which advertising windows are present. A chat room is a computer site that can be accessed simultaneously by many users, with each user being able to enter text material intended to be conversational in nature. The text material of each user is relayed to all the other users present in the chat room, allowing the users to interact and respond to each other. However, the method of Moncreiff is not primarily intended for advertising.

While it is conceivable that television and the Web will someday merge, currently the two media are basically separate and distinct, and advertising is carried out in an isolated manner on one or the other medium, but not both simultaneously, in coordination with each other. For a general discussion on the merging of television and the Web, see Yang, Dori J., A Boob Tube with Brains: High-tech Heavies Battle to Bring Smart TV to Your Living Room, U.S. NEWS & WORLD REPORT, Mar. 13, 2000, at 42. One reference which peripherally discloses advertising in the context of both television and the Web is Schein et al. (U.S. Pat. No. 6,002,394; 1999). Schein et al. teaches a system and methods for linking television viewers with advertisers and broadcasters via the Web during a television broadcast. This invention is directed to a TV system that provides television-schedule information to a viewer. Peripherally, users may interact with on-line advertising databases in the method of Schein et al., but these databases are pre-existing and the system of Schein et al. merely links to them.

What is needed, therefore, is a method of providing cross-medium advertising that takes advantage of the advertising strengths inherent in the particular advertising media. What is further needed is such a method that uses the Web as one of the media. What is yet further needed is such a method that is adaptable to customizing advertisements to a particular individual.

### SUMMARY OF THE INVENTION

It is an object of the present invention to provide a method of cross-medium advertising in which the Web is used as one of the media. It is a further object to provide such a method that combines the advantages of passive viewing associated with television viewing and active searching associated with Internet use. It is a yet further object to provide such a method that provides consumers access to local advertising.

In the practice of the present invention, an advertiser, hereinafter referred to as a subscribing-advertiser, places an advertisement in a first advertising medium, and then contracts with an “advertising-contractor”—either a party associated with the first advertising medium, or a third party—for additional advertising content related to the advertisement in the first medium. By “party associated with the first advertising medium” is meant a party having a contractual, fiduciary, or employment relationship with the first advertising medium and/or management/executives thereof. Such parties may include publishers, television station personnel, radio station personnel. Multiple subscribing-advertisers may contract with the advertising-contractor.

A subscribing-advertiser contracting with the advertising-contractor receives extended advertising content on the World Wide Web that is coordinated with the subscribing advertiser's advertisement in the first advertising medium. The advertising-contractor provides an identifier that relates the subscribing advertiser's advertisement in the first advertising medium with the extended advertising content on the World Wide Web. This identifier is a visual and/or audio cue, depending on what type of cue is effective for the particular medium. This identifier can be directly attached to the subscribing advertiser's advertisement, such as a visual icon on the advertisement, or can be separate from the advertisement, but is a pointer that directs the viewer to another medium for more information about the particular advertisement(s) of interest. This cue is typically a URL-pointer that is placed in one or more first advertising media, and is hereinafter referred to as a “Bug,”. The Bug directs the viewer to the advertising-contractor's extended advertising content, that is, creates a link between the advertisements of a group of subscribing advertisers and the extended advertising content, irrespective of the particular first advertising medium or subscribing-advertiser.

This Bug identifies a Web site that is designed by the advertising-contractor and which, among its multiple functions, serves to list all the subscribing-advertisers and/or all of the advertisements placed by these subscribing-advertisers in the one or more first advertising media. The Web site identified by the Bug, hereinafter referred to as the Mall-Site, is analogous to a shopping mall that presents to a consumer numerous attention-grabbing displays, including advertisements, advertiser names, notices of contests, special offers, etc. The first advertising medium in which the Bug is placed can be any communications medium (e.g., television, radio, newspapers, billboards, magazines, e-mail groups, Morse code, Braille messages, hot-air balloons, skywriting, pantomime, cattle-branding, paintings, sculpture, tattoos, Origami, to name just a few, or any combination thereof.)

The Bug provided by the advertising-contractor is displayed, or broadcast, in context with the advertisement in the first medium. Alternatively, the Bug itself may be the advertisement in the first medium. The Bug remains consistent from advertisement to advertisement within the first medium and, thus, it is memorable.

The Bug is presented to a potential customer in the first medium in a way that takes advantage of the passive mode of viewing by a potential consumer. That is, the Bug is presented in a television broadcast, in print, on the Web, without the viewer requesting it. Upon noticing the Bug and desiring more information, the viewer enters into an interactive mode and enters the Bug, i.e., the URL of the Mall-site, in his or her Web-browser (or other means of navigating the Web, including Web-TV, or PCTV) to gain access to the Mall-site.

The Mall-site, as previously mentioned, includes a listing of (1) the advertisement(s) of the participating subscribing-advertiser(s) and/or (2) the names or logos of the individual subscribing-advertisers. Included on the Mall-site are Web-links, corresponding to either or both of (1) and (2) and which link from the consumer's current page to other Web pages. If desired, one of the Web-links may link to the advertiser's own Web site. At present, these links are provided in appropriate Hypertext Mark-up Language (HTML); the present invention, however, is not limited to any particular form of Web-link and will have increased utility as new forms and combinations of Web-programs/applications are developed. Each of the Web-links in the Mall-site directs the consumer to one or more additional Web-pages which display supplemental information about the products or services advertised in the advertisement and/or the names or logos of the participating subscribing-advertisers. These supplemental Web-pages are provided by the advertising-contractor. Thus, the Web, or rather, the Mall-site, becomes a second advertising medium in which extended advertising content is correlated to advertisements in first advertising media.

The present invention can be thought of as a “funnel” for consumers, guiding them toward advertising content that supplements that of the subscribing-advertiser(s). The various first-advertising media act as the mouth of the funnel, collecting consumers from the different first-advertising media who have seen and reacted to the Bug placed by the subscribing-advertisers. The Bug acts as the throat of the funnel, through which the consumers are drawn to the Mall-site on the Web. The Mall-site provides supplemental advertising content to a subscribing-advertiser's advertisement in a first medium, and then draws people to this supplemental content.

The method according to the present invention may include: monitoring the consumer's choices and web-browser selections after the consumer has accessed the extended advertising content; providing statistical data or an accounting of the monitoring; and reporting the accounting to each subscribing-advertiser or party of the first medium who has contracted for the report. In one exemplary embodiment, monitoring is done by tracking web-page hits, menu/button selection, transactions made, time spent on pages of a particular advertiser, and the number of click-throughs from one site to another one. Monitoring may include the use of cookies, which are small packets of information placed on the consumer's computer that allow the cookie-placing Web site to identify the consumer.

As mentioned above, the Bug is consistent throughout the particular medium it appears in so that it becomes easily identifiable and memorable. Depending on the subscribing-advertiser's needs, the Bug may also include context-information that identifies the context of the first advertisement. In this context-sensitive embodiment, slightly modified Bugs may be used for a particular commercial, depending on the context in which the commercial is shown. Context-information may include, for example, the television show, the time during which, or the geographic location where, the commercial is shown. The Bug points to a specific Web-server and a file on that server, and each Bug includes the context-information, which may take the form of a different file on the specified server. Because the Bug is different for each advertisement (and may be different between the same advertisement shown in different contexts), the consumer's behavior upon accessing the specific Web-page indicates to a degree the effectiveness of the first advertisement in the first medium in each particular context. Typical statistical measurements of effectiveness include hits, page-views, click-through, time spent on the page/file/server, and transactions made/recorded. The statistical data compiled provides a means for evaluating the effectiveness of advertisements made in non-Web media.

Additionally, the extended advertising content can be accessed without prior knowledge of the Bug. For example, consumers, through general knowledge of the Web Mall-site, may go directly to the Mall-site to research products of interest. Furthermore, consumers may use an internet search engine to find access to the Web Mall-site. Alternatively, the Web Mall-site may advertise itself through the use of various advertising media, such as television, radio, print, or even Web links from other Web sites.

If the consumer accesses the Mall-site through an Interactive TV system (such as through a cable or satellite provider), the Mall-site will recognize the geographic location of the person subscribing to the interactive TV service, and then automatically direct the consumer to a local or regional advertising Mall-site, thereby providing the consumer with access to local or regional (as opposed to national or international) advertising and special offers. For example, if the consumer views a national advertisement for an automobile and wishes to get more information from his/her local dealer, the consumer can access the Mall-site for additional information such as special offers or availability. Additionally, depending on the retailer, the consumer may execute order or payment transactions right from the Mall-site via secured servers, or through the retailer's or other third party's secured server.

Another function included in the Mall-site is a membership section that provides “members” with general or customized information, including coupons and/or special offers, in exchange for limited personal and demographic information about themselves and/or information about their shopping habits/interests. A “member” in this context is a user who has signed on to receive additional benefits, generally provided in the form of periodical communications that contain coupons and/or special offers. When a Web-user signs up as a member, the Mall-site customizes the member's entry page upon identification of the member and provides the member coupons or special offers on items offered by local advertisers that correlate with the member's designated shopping preferences. These coupons or special offers can be sent to the member via e-mail, traditional mailing, or provided as a certificate that is downloadable or printable from the Internet.

The communications can be of a general type that include offers and coupons from any number of subscribing advertisers, or a customized type that contains offers in product or service categories that have been selected by the member. So, for example, if the member selects “sporting goods and accessories” as one of his or her preferences, the Mall-site automatically customizes that member's entry page upon the next visit to display ads, special offers, and/or coupons relating to sporting goods. Alternatively, these coupons, which are preferably made available exclusively to Mall-site users, are mailed or e-mailed to the member.

Furthermore, members of the Mall-site can receive various e-mail bulletins and newsletters at an interval set by the Mall-site, such as weekly, monthly, or both. These bulletins and newsletters can be specifically tailored to the designated interests of the members, either through actual selection by the member of that area of interest, or through tracking of the member's choices by the Mall-site, through the use of cookies. Alternatively, the bulletins or newsletters can include general information (meaning special offers, advertisements, or coupons) pertaining to areas not selected by the member, thereby exposing the member to new products or services.

### BRIEF DESCRIPTION OF THE DRAWINGS

FIG. 1 is a block-diagram illustrating the Preferred Embodiment of the method according to the present invention.

FIG. 2 shows an example of a list-page used in the Preferred Embodiment of the present invention.

FIG. 3 shows an example of first-advertisement-specific content-page generated by the Preferred Embodiment of the method of the present invention.

FIG. 4 shows an additional content page associated with the particular first-advertisement-specific content-page of FIG. 3.

### DETAILED DESCRIPTION OF THE PREFERRED EMBODIMENT

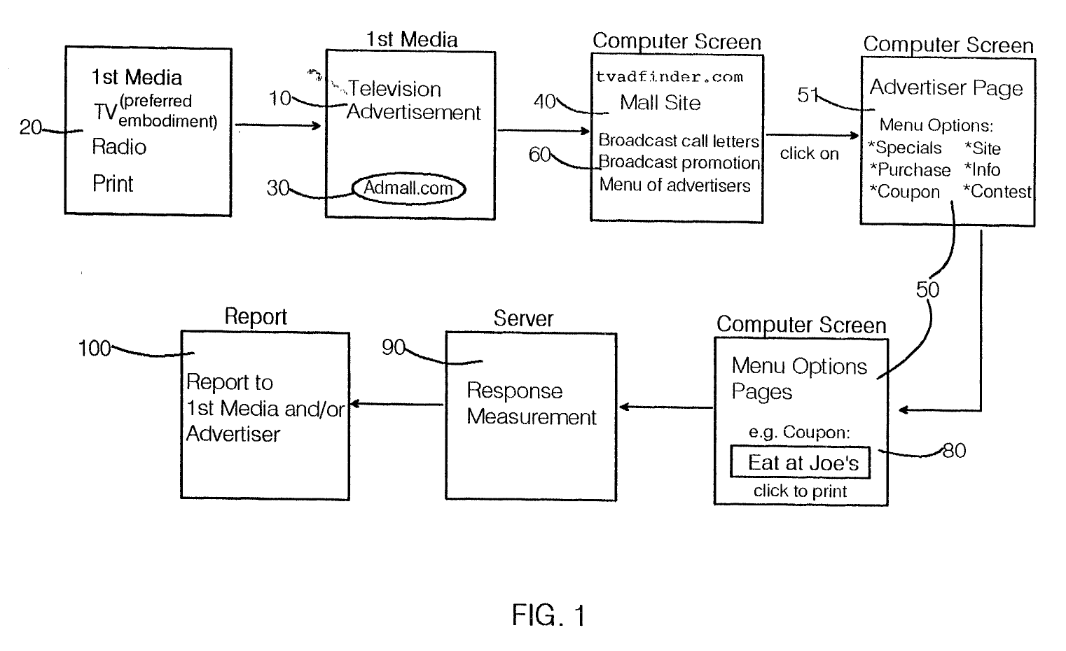

The Preferred Embodiment of the present invention, illustrated schematically in FIGS. 1-5, is set forth below. This Preferred Embodiment is merely one embodiment of the present invention and is not meant to limit the scope of the present invention.

By block diagram, FIG. 1 illustrates the steps the Preferred Embodiment of the present invention: a subscribing-advertiser has caused a first advertisement 10 to be broadcast on television. Television broadcast is thus hereinafter referred to as a first advertising medium 20 in the Preferred Embodiment. The subscribing-advertiser contracts with an advertising-contractor for the coordination of extended advertising content 11 that is related to and/or links to the subscribing-advertiser's first advertisement 10. This extended advertising content 11 includes a Mall-site 40 that functions, among other things, as a catalog or menu of advertisers and/or advertisements. The extended advertising content 11 also includes supplemental first-advertisement content-pages 50 that relate specifically to the first advertisement.

An identifier 30, also referred to as a Bug, serves as a link to the extended advertising content 11 of the first medium 20. This identifier 30, typically a visual icon, is shown, or presented, in the context of the first advertisement 10, i.e. the television commercial. When the identifier 30 is used in an advertisement medium that does not lend itself to visual icons, such as radio, then an audio identifier is used. In the Preferred Embodiment, the identifier 30 is a visual icon and indicates the URL of the Mall-site 40, www.tvadfinder.com. The supplemental first-advertisement content-pages 50 are indicated and accessed by Web-links coded in HTML as “buttons” 60 which are shown on the Mall-site 40. The supplemental first-advertisement content-pages 50 include, for each subscribing-advertiser, an advertisement-specific menu-page 51 which links a Web-user to supplemental-content Web-pages 80 containing information related to the first-advertisement 10 or related to the respective subscribing-advertiser.

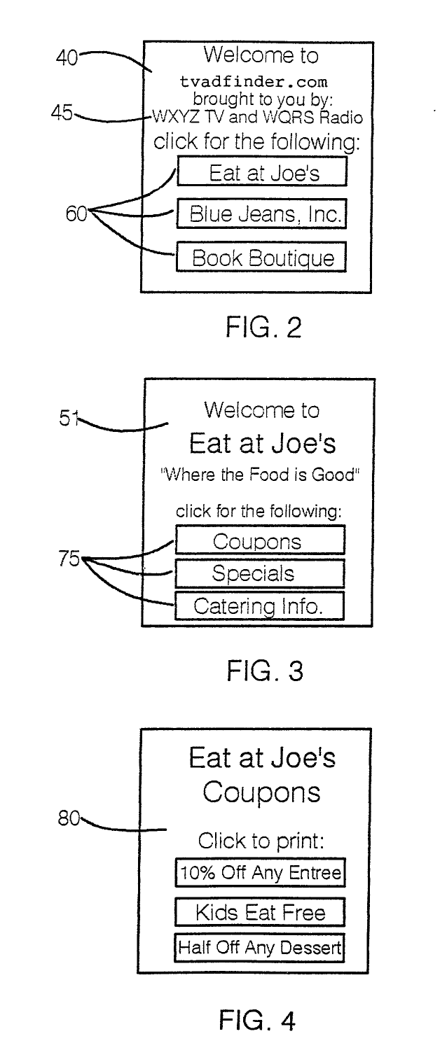

The Mall-site 40 is shown in FIG. 2. This Mall-site 40 is accessed by a Web-user who has seen the www.tvadfinder.com Bug or identifier 30 that was placed in the first advertisement 10 that was broadcast on television. In the Preferred Embodiment, the advertising-contractor provides extended advertising content 11 from multiple advertisers, with the result being that the Mall-site 40 has a plurality of Web-links, in this case, buttons 60, whereby each button 60 links to a specific first advertisement 10 and/or subscribing advertiser. Preferably, the Mall-site 40 also shows the call letters 45 of the stations on which these multiple advertisers have advertised.

FIG. 3 shows a representative one of the first-advertisement-specific content pages 51 that has been selected by the Web-user. This first-advertisement-specific content-page 51 includes one or more advertisement-specific menu-buttons 75 which link the Web-user to supplemental-content Web-pages 80 containing information related to the advertisement-specific menu-buttons 75. In the Preferred Embodiment, these supplemental-content Web-pages 80 include information specific to the first advertisement 10, such as coupons, contests, special offers, and purchasing information. FIG. 4 shows a representative example of the supplemental-content Web-pages 80.

In the Preferred Embodiment, once the Web-user accesses the Mall-site 40 and the additional first-advertisement-specific content-pages 50, statistical data 90 are gathered regarding the Web-user's selections or choices. These statistical data 90 include hits per Web-page, selections of the Web-link button 60 or menu-button 75, number and path of click-throughs, time spent on a particular Web-page, and any transaction made from a Web-page. The statistical data 90 can, but do not necessarily, include the use of cookies. A report 100 of the statistical data 90 is prepared by the advertising-contractor and sent to each of the subscribing-advertisers and/or to parties related to the first medium 20.

According to the Preferred Embodiment of the invention, the Web-user receives an invitation to sign up as a “member” of the Mall-site. In exchange for providing some information about personal buying habits and preferences, as well as some personal information such as age, gender, etc. that is relevant for marketing purposes, members are sent bulletins, newsletters, or other types of communications on a periodical basis. These bulletins etc. contain coupons and/or special offers of local advertisers. Preferably, such offers are made available only to members.

What is claimed is:

1. An advertising method, wherein a subscribing-advertiser contracts with a contracting-advertiser to provide extended advertising content that relates to a first advertisement, said method comprising the following steps:
a) placing said first advertisement in a first advertising medium;
b) providing a subscription service to subscribing-advertisers by said contracting-advertiser for providing extended advertising content in a second advertising medium that is on the World Wide Web;
c) providing a linked plurality of Web-pages that displays said extended advertising content;
d) providing an identifier in said first advertisement that is adaptable as a first link between said first advertisement in said first advertising medium and a first page of said linked plurality in said second advertising medium; and
e) providing at least one additional link in said linked plurality of Web-pages to at least one Web-page that is included in said linked plurality, said at least one additional Web-page containing information related to said first advertisement.

2. The advertising method of claim 1, wherein said first medium is selected from the group consisting of television broadcast, radio broadcast, electronic display screens, and print.

3. The advertising method of claim 1, further comprising the step of placing a second advertisement in said second advertising medium.

4. The advertising method of claim 3, wherein said at least one additional link second link links to said second advertisement.

5. The advertising method of claim 4, wherein said linked plurality of Web-pages contains at least one additional Web-page containing information related to said second advertisement.

6. The advertising method of claim 2, wherein said subscribing-advertiser includes a plurality of advertisers and said first advertisement includes a plurality of first advertisements, and wherein each one of said plurality of advertisers has an advertisement that is said first advertisement in said first medium, said first medium being any one first medium of said group.

7. The advertising method of claim 6, wherein said linked plurality of Web-pages includes at least one Web-page from each of said subscribing-advertisers.

8. The advertising method of claim 1, wherein a Web-user has access to said extended advertising content on said World Wide Web, said method further comprising the following steps:
a) providing said Web-user access to a personal membership information page;
b) providing a means for said Web-user to become a member;
c) recording personal and/or demographic information of said member and tracking a behavior of said member in said linked plurality of Web-pages; and
d) providing additional benefits to said member.

9. The method of claim 8, wherein said additional benefits includes special offers and/or coupons.

10. The method of claim 9, wherein said special offers and/or coupons are from local subscribing advertisers.

11. The method of claim 8, wherein said additional benefits are provided exclusively to said member.

12. The method of claim 8 further comprising the following steps:
a) providing a list of categories for services and/or products;
b) allowing said Web-user to choose one or more of said categories; and
c) providing said Web-user with a bulletin wherein said special information is from said one or more of said categories selected by said Web-user.

13. The method of claim 12, wherein said step of providing said bulletin includes transmission of said bulletin by one or more of transmission modes.

14. The method of claim 13, wherein said transmission modes include sending an e-mail with said bulletin to said Web-user, mailing said bulletin to said Web-user, and providing said bulletin online on said World Wide Web.
